(19) United States
(12) Patent Application Publication
(10) Pub. No.: US 2007/0073844 A1
(43) Pub. Date: Mar. 29, 2007

(54) Method, system, and program product for web services orchestration

(75) Inventors: David L. Schmidt, Cary, NC (US); Kyle L. Croutwater, Chapel Hill, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/236,949

(22) Filed: Sep. 28, 2005

(51) Int. Cl. G06F 15/16

(52) U.S. Cl. 709/219

(57) ABSTRACT

The invention provides a method, system, and program product for orchestrating web services. In one embodiment, the method includes accessing a plurality of web services, each web service including an orchestration engine; and employing a program including an instruction for work executed by at least one of the plurality of web services.

### BACKGROUND OF THE INVENTION

1. Technical Field

The invention relates generally to web services, and more particularly, to a method, system, and program product for coordinating the actions of distributed web services using an imbedded orchestration engine.

2. Background Art

Web services provide many functions and are capable of performing various tasks, such as database queries, computational functions, graphical and/or auditory rendering, message delivery, etc. In some instances, it is desirable or necessary to utilize more than one web service to complete a particular task or function. However, the web services needed may be provided by disparate providers and employ different protocols. Often, such protocols are proprietary or platform-specific, making the interoperability of web services difficult or impossible. For example, even though two web services utilize an extensible markup language (XML) calling convention, their XML payloads may differ. In order for two such web services to communicate, each must know (1) the other's address and (2) the other's XML payload. Often, all XML payloads are not supported, making the interoperability of web services with unsupported XML payloads impossible.

Attempts have been made to facilitate the interoperability of web services, regardless of their individual protocols. For example, Web Services Coordination (WS-Coordination) provides an extensible framework of coordination protocols that enables disparate web services to cooperate in the performance of a multi-part function or task. However, WS-Coordination and similar approaches do not coordinate or standardize the various protocols of web services. Rather, they provide additional protocols that permit web services to cooperate. As a result, it is necessary to know of and provide for each web service protocol that may be encountered. If a particular protocol is not provided for in the coordination protocol, a web service utilizing that protocol may not be integrated into the group of web services available to a user.

For example, WS-Coordination utilizes protocol models, such as Simple Object Access Protocol (SOAP) and Web Services Description Language (WSDL). Web services that are SOAP- and/or WSDL-enabled may be coordinated using WS-Coordination. A web service that is not SOAP- and/or WSDL-enabled cannot be combined with SOAP- and/or WSDL-enabled web services and cannot be coordinated using WS-Coordination.

To this extent, a need exists for a method of orchestrating web services that does not suffer from the deficiencies above.

### SUMMARY OF THE INVENTION

The invention provides a method, system, and program product for orchestrating web services. In one embodiment, the method includes accessing a plurality of web services, each web service including an orchestration engine; and employing a program including an instruction for work executed by at least one of the plurality of web services.

A first aspect of the invention provides a method of orchestrating web services, the method comprising: accessing a plurality of web services, each web service including an orchestration engine; and employing a program including an instruction for work executed by at least one of the plurality of web services.

A second aspect of the invention provides a system for orchestrating web services, the system comprising: a system for accessing a plurality of web services, each web service including an orchestration engine; and a system for employing a program including an instruction for work executed by at least one of the plurality of web services.

A third aspect of the invention provides a program product stored on a computer-readable medium, which when executed, orchestrates web services, the program product comprising: program code for accessing a plurality of web services, each web service including an orchestration engine; and program code for employing a program including an instruction for work executed by at least one of the plurality of web services.

A fourth aspect of the present invention is directed to a method for orchestrating web services, the method comprising: providing a computer infrastructure being operable to: access a plurality of web services, each web service including an orchestration engine; and employ a program including an instruction for work executed by at least one of the plurality of web services.

A fifth aspect of the present invention is directed to computer software embodied in a propagated signal for orchestrating web services, the computer software comprising instructions to cause a computer system to perform the following functions: access a plurality of web services, each web service including an orchestration engine; and employ a program including an instruction for work executed by at least one of the plurality of web services.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system according to one embodiment of the invention.

FIG. 2 shows a schematic diagram of an interaction of a program and web service farm according to the invention.

FIG. 3 shows a detailed view of a portion of FIG. 2.

FIG. 4 shows a flow diagram of an illustrative method of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system, and program product for orchestrating web services.

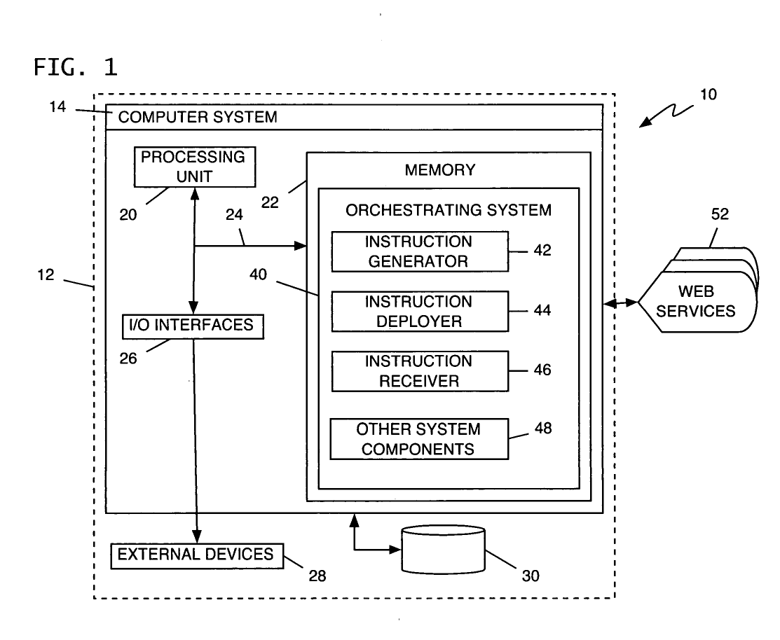

Turning to the drawings, FIG. 1 shows an illustrative system 10 for orchestrating web services. To this extent, system 10 includes a computer infrastructure 12 that can perform the various process steps described herein for orchestrating web services. In particular, computer infrastructure 12 is shown including a computer system 14 that comprises an orchestrating system 40, which enables computing device 14 to orchestrate web services by performing the process steps of the invention.

Computing device 14 is shown including a processing unit 20, a memory 22, an input/output (I/O) interfaces 26, and a bus 24. Further, computing device 14 is shown in communication with an external I/O devices 28 and a storage system 30. As is known in the art, in general, processing unit 20 executes computer program code, such as orchestrating system 40, that is stored in memory 22 and/or storage system 30. While executing computer program code, processing unit 20 can read and/or write data, such as orchestrating system 40, to/from memory 22, storage system 30, and/or I/O interface 26. Bus 24 provides a communication link between each of the components in computing device 14. I/O device 28 can comprise any device that enables a user to interact with computing device 14 or any device that enables computing device 14 to communicate with one or more other computing devices.

In any event, computing device 14 can comprise any general purpose computing article of manufacture capable of executing computer program code installed by a user (not shown) (e.g., a personal computer, server, handheld device, etc.). However, it is understood that computing device 14 and orchestrating system 40 are only representative of various possible computing devices that may perform the various process steps of the invention. To this extent, in other embodiments, computing device 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

As previously mentioned and discussed further below, orchestrating system 40 enables computing device 14 to orchestrate web services. To this extent, orchestrating system 40 is shown including an optional instruction generator 42, an instruction deployer 44, an optional instruction receiver 46, and other system components 48. Optional instruction generator 42 generates instructions for work to be executed by one or more of a plurality of web services 52. Instruction deployer 44 deploys instructions for work to the plurality of web services 52, whether the instructions for work are generated by optional instruction generator 42 or otherwise. Optional instruction receiver 46 receives updated instructions for work from one or more of the plurality of web services 52. Other system components 48 may include any component providing functionality to orchestrating system 40 including, for example, transmission systems, communication systems, etc. However, it is understood that some of the various systems shown in FIG. 1 can be implemented independently, combined, and/or stored in memory for one or more separate computing devices 14 that communicate over a network. Further, it is understood that some of the systems and/or functionality may not be implemented, or additional systems and/or functionality may be included as part of system 10.

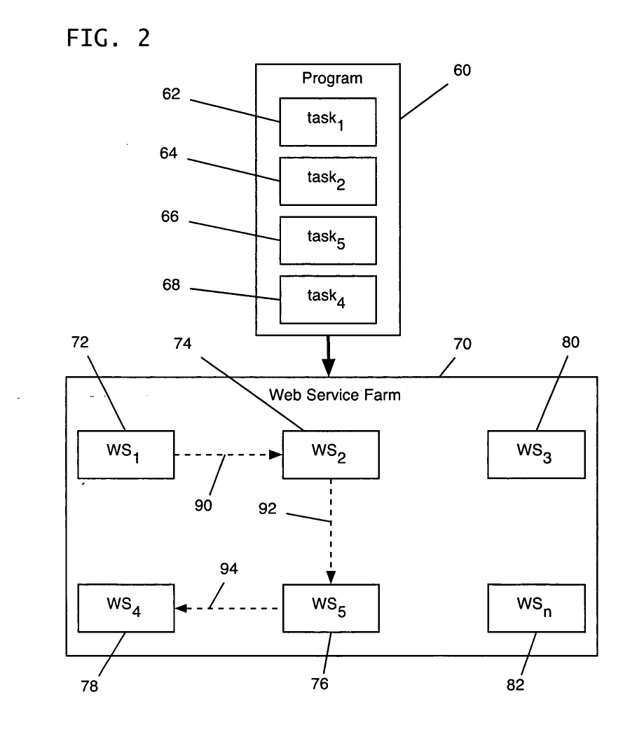

Regardless, the invention provides a method, system, and program product for orchestrating web services. To this extent, FIG. 2 shows an illustrative embodiment of the invention, wherein an orchestration program 60 is communicated to a web service farm 70. Program 60 includes an orchestration language based on any known or later-developed assembly language, as would be known to one skilled in the art. As such, program 60 may include instructions for governing the flow and control of program instructions, looping constructs, arithmetic functions, etc. Program 60 includes instructions for the execution of a plurality of tasks 62, 64, 66, 68. Tasks 62, 64, 66, 68 may include any task, function, operation, etc. executable by a web service, including, for example, database queries, email notifications, stock quote look-ups, computations, etc. However, as will be described in greater detail below, unlike known methods and systems of web service orchestration, program 60 includes an instruction for a first web service to “call” and/or “be called by” a second web service, enabling the tasks 62, 64, 66, 68 of program 60 to be executed by more than one web service.

Still referring to FIG. 2, a farm 70 of general purpose web services is accessed in order to execute the tasks of program 60. For example, as shown, web service 1 (WS₁) 72 is capable of executing task₁ 62. Similarly, WS₂ 74 can execute task₂ 64, WS₄ 78 can execute task₄ 68, and WS₅ can execute task₅ 66. Other web services (e.g., WS₃, WSₙ) may similarly be capable of executing one or more tasks of program 60 and a single web service may be capable of executing more than one task.

Upon receipt of program 60, WS₁ 72 executes task₁ 62 and passes 90 program 60 to WS₂ 74. WS₂ 74 then executes task₂ 64 and passes 92 program 60 to WS₅ 76. Finally, WS₅ 76 executes task₅ 66 and passes 94 program 60 to WS₄ 78, which executes task₄ 68. Program 60 may include a predefined order in which its tasks are to be executed. Alternatively, program 60 may include no such predefined order, with the order in which the tasks are executed being determined by the availability of particular web services. In the case that program 60 contains no such predefined order of task execution, program 60 may be passed between web services in any number of orders, based, in part, on the availability of individual web services. For example, still referring to FIG. 2, assuming that program 60 contains no predefined order in which its tasks are to be executed, if WS₁ is unavailable (e.g., due to it being engaged in the execution of a task of another program), WS₂ 74 may first execute task₂ 64 and then pass program 60 to WS₁ 72, should WS₁ 72 then be available. If WS₁ 72 is still not available, WS₂ 74 may pass program 60 to WS₄ 78 or WS₅ 76 for execution of task₄ 68 or task₅ 66, respectively.

In some cases, program 60 may include a predefined order of task execution. For example, the execution of some tasks may be dependent upon the earlier execution of other tasks. For example, still referring to FIG. 2, in the case that task₁ 62 and task₂ 64 include database queries and task₃ 66 includes instructions to add together the results of task₁ 62 and task₂ 64, execution of task₃ 66 is dependent upon the execution of task₁ 62 and task₂ 64. Similarly, portions of program 60 may include a predefined order of task execution while other portions do not. Referring again to the example above, task₁ 62 may be executed before or after task₂, provided both are executed before task₃ 66.

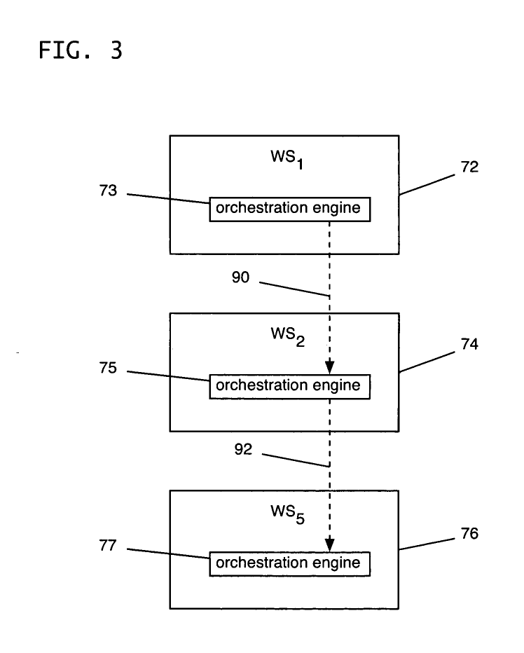

Referring now to FIG. 3, a detailed view of orchestration among web services is shown. As shown, each web service 72, 74, 76 includes an orchestration engine 73, 75, 77. Orchestration engines 73, 75, 77 operate much like an electronic central processing unit (CPU) emulator. That is, orchestration engine 73, 75, 77 may execute instructions provided the web service 72, 74, 76, keep a program counter and/or status register, etc. Unlike known methods and systems, however, orchestration engine 73, 75, 77 enables one web service (e.g., 72) to “call” another web service (e.g., 74 and/or 76). Similarly, orchestration engine 73, 75, 77 enables a web service to be “called by” other web services. In other words, an orchestration engine of the present invention allows distinct web services to communicate with each other and, preferably, transmit to each other a status of a program or set of instructions to be executed by the web services.

For example, still referring to FIG. 3, after executing one or more tasks of a program (not shown), the program is passed 90 from orchestration engine 73 of WS₁ 72 to orchestration engine 75 of WS₂ 74. The program is passed to orchestration engine 75 including information regarding what tasks have already been performed by WS₁ 72. Thus, tasks are not unnecessarily re-executed. In addition, where the program includes a predefined execution order, as described above, such transfer of the program along with information regarding its execution status enables the program to be passed to some web services or not passed to other web services.

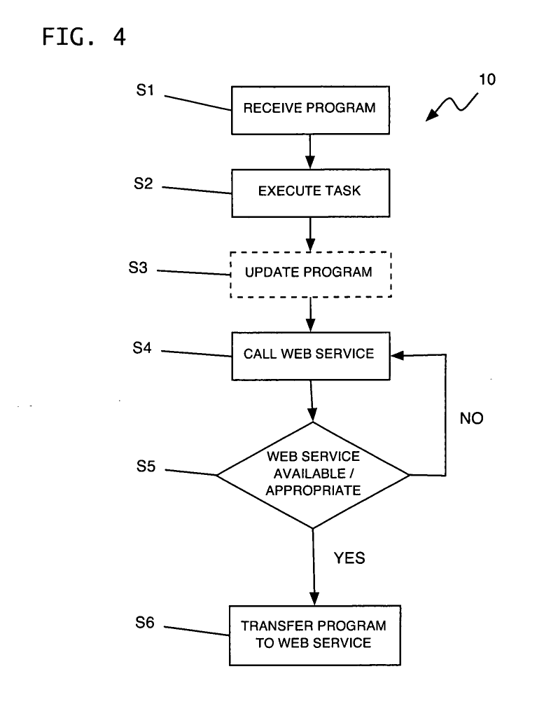

FIG. 4 shows an illustrative embodiment of a method 110 according to the present invention. At step S1, a program 60 (FIG. 2) is received by a web service. Next, at step S2, the web service executes one or more tasks of program 60. At step S3, the web service may optionally update program 60, recording the task or tasks executed. Next, at step S4, another web service is “called,” as described above. At step S5, if the called web service is available to further execute tasks of program 60 and/or is an appropriate web service to execute such tasks (e.g., the task executable by the called web service is not dependent on unexecuted tasks), program 60 is transferred to the called web service at step S6. If the called web service is not available or is not an appropriate web service, the web service is “re-called” or another web service is called.

While shown and described herein as a method, system, and program product for orchestrating web services, it is understood that the invention further provides various alternative embodiments. For example, in one embodiment, the invention provides a computer-readable medium that includes computer program code to enable a computer infrastructure to orchestrate web services. To this extent, the computer-readable medium includes program code, such as orchestrating system 40 (FIG. 1), which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to orchestrate web services as described above. In this case, the service provider can create, maintain, support, etc., a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for orchestrating web services. In this case, a computer infrastructure, such as computer infrastructure 12 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of orchestrating web services, the method comprising:
accessing a plurality of web services, each web service including an orchestration engine; and
employing a program including an instruction for work executed by at least one of the plurality of web services.

2. The method of claim 1, wherein the instruction for work includes an instruction to pass the instruction for work from a first of the plurality of web services to a second of the plurality of web services.

3. The method of claim 2, wherein a first portion of the work is executed by the first of the plurality of web services and a second portion of the work is executed by the second of the plurality of web services.

4. The method of claim 3, wherein the instruction for work is updated by the first web service to reflect executed tasks.

5. The method of claim 3, wherein the instruction for work includes an order of web services in which the program is to be passed.

6. The method of claim 2, wherein the instruction for work includes an assembly language.

7. The method of claim 1, wherein the orchestration engine is adapted to allow a first of the plurality of web services to call a second of the plurality of web services.

8. The method of claim 1, wherein the orchestration engine is adapted to allow a first of the plurality of web services to be called by a second of the plurality of web services.

9. A method of generating a system for orchestrating web services, the method comprising:
obtaining a computer infrastructure; and
for each of the steps of claim 1, deploying a means for performing the step to the computer infrastructure.

10. A computer-readable medium for enabling a computer infrastructure to orchestrate web services, the computer-readable medium comprising computer program code for performing the method steps of claim 1.

11. A system for orchestrating web services, the system comprising:
a system for accessing a plurality of web services, each web service including an orchestration engine; and
a system for employing a program including an instruction for work executed by at least one of the plurality of web services.

12. The system of claim 11, wherein the instruction for work includes an instruction to pass the instruction for work from a first of the plurality of web servicew to a second of the plurality of web services and a first portion of the work is executed by the first of the plurality of web services and a second portion of the work is executed by the second of the plurality of web services.

13. The system of claim 12, wherein the instruction for work includes an order of web services in which the program is to be passed.

14. The system of claim 11, wherein the orchestration engine is adapted to allow a first of the plurality of web services to call and be called by a second of the plurality of web services.

15. A program product stored on a computer-readable medium, which when executed, orchestrates web services, the program product comprising:
program code for accessing a plurality of web services, each web service including an orchestration engine; and
program code for employing a program including an instruction for work executed by at least one of the plurality of web services.

16. The program product of claim 15, wherein the instruction for work includes an instruction to pass the instruction for work from a first of the plurality of web servicew to a second of the plurality of web services.

17. The program product of claim 16, wherein a first portion of the work is executed by the first of the plurality of web services and a second portion of the work is executed by the second of the plurality of web services.

18. The program product of claim 17, wherein the instruction for work is updated by the first of the plurality of web services to reflect executed tasks.

19. The program product of claim 17, wherein the instruction for work includes an order of web services in which the program is to be passed.

20. The program product of claim 15, wherein the orchestration engine is adapted to allow a first of the plurality of web services to call and be called by a second of the plurality of web services.
